(19) United States
(12) Patent Application Publication
(10) Pub. No.: US 2001/0054620 A1
(43) Pub. Date: Dec. 27, 2001

(54) Cylindrical tissue dispenser

(76) Inventors: Wonda Blissett, Houston, TX (US); Rafael G. Andrade, Pasadena, TX (US)

Correspondence Address: George L. Williamson, P.O. Box 508, Fairhope, AL, 36533, US

(21) Appl. No.: 09/854,130

(22) Filed: May 11, 2001

Related U.S. Application Data
(60) Provisional application No. 60/203,953, filed on May 12, 2000.

(51) Int. Cl. A47F 1/04; G07F 11/16

(52) U.S. Cl. 221/307; 221/310

(57) ABSTRACT

The present invention discloses a tissue dispenser being a box which is cylindrically shaped whereby the box can be stored in commercially available receptacles designed for holding cylindrical containers, such as found in a motor vehicle. The box is designed to have a central slot in its top through which the tissues are dispensed.

This application claims benefit of Provisional Application Ser. No 60/203,953 filed on May 12, 2000.

### BACKGROUND OF THE INVENTION

1. Field of the Invention

The present invention relates generally to tissue dispensers and, more particularly, is concerned with a cylindrical tissue dispenser.

2. Description of the Prior Art

Tissue dispensers have been described in the prior art. However, none of the prior art devices disclose the unique features of the present invention.

In U.S. Pat. No. 5,695,160 dated Dec. 9, 1997, Cockrum disclosed an apparatus for holding a box of tissues, foliage, or other items having two receptacles. The apparatus may be used as a base or form for craft projects such as a hand decorated tissue box cover or flower pot holder. The holder apparatus includes an exterior receptacle surrounding an interior receptacle. The interior receptacle has adjacent sides substantially perpendicular to a central base. The exterior receptacle extends around the outer perimeter of the interior receptacle and has a base in a horizontal plane below the base of the interior receptacle. The side walls of the exterior receptacle curve outward radially away from the side walls of the interior receptacle.

In U.S. Pat. No. Des. 389,682, dated Jan. 27, 1998, Gene disclosed the ornamental design for a tissue box holder, as shown and described.

In U.S. Pat. No. Des. 378,330 dated Mar. 11, 1997, Spaseska disclosed the ornamental design for a tissue box, as shown and described.

In U.S. Pat. No. Des. 377,902, dated Feb. 11, 1997, Marucci disclosed the ornamental design for a wet wipe container, as shown and described.

In U.S. Pat. No. Des. 371,708, dated Jul. 16, 1996, Haley, et al., disclosed the ornamental design for a tissue box holder, as shown and described.

In U.S. Pat. No. Des. 372,386, dated Aug. 6, 1996, Kuchenbecker disclosed the ornamental design for a facial tissue box, as shown and described.

In U.S. Pat. No. 5,544,750, dated Aug. 13, 1996, Randall disclosed a portable holder for tissues to carry full size tissues right from a tissue box. The holder is to be die cut from flexible transparent material such as vinyl. The holder has having two like pockets on interior surface so aligned as to create a channel for the insertion of an insert cut to fit the rectangular main body of holder for tissue. Transparency of holder allows the insert to be seen through holder thereby becoming the decor of holder. With the insert in place, tissues are placed over the insert, the holder is folded and the fastener is secured.

In U.S. Pat. No. 5,358,692, dated Oct. 25, 1994, Reynolds disclosed a tissue cassette holder including a rectangular open-top tray having a pair of looking side rails affixed to the upper portion of the longitudinal sides thereof, the rails having a raised elastomeric protuberance projecting inwardly from the center thereof and spaced sufficiently apart to permit a conventional tissue cassette to snap firmly therebetween. Preferably, the trays are configured to permit removably locking a plurality thereof into superposed and/or side-by-side relationship, and further to positively lock a plurality of cassettes within each such tray for liquid processing and to break such cassettes loose after the tray and cassettes are wax-dipped preparatory to slicing the tissue therein for microanalysis.

In U.S. Pat. No. Des. 380,325, dated Jul. 1, 1997, Kempf disclosed the ornamental design for an adjustable holder for a tissue box, as shown and described.

While these tissue dispensers may be suitable for the purposes for which they were designed, they would not be as suitable for the purposes of the present invention, as hereinafter described.

### SUMMARY OF THE INVENTION

The present invention discloses a tissue dispenser being a box which is cylindrically shaped whereby the box can be stored in commercially available receptacles designed for holding cylindrical containers, such as found in a motor vehicle. The box is designed to have a central slot in its top through which the tissues are dispensed.

An object of the present invention is to provide a tissue box which can be stored in receptacles designed for receiving cylindrical containers. Another object of the present invention is to provide an easy and convenient way for a driver of a motor vehicle to access tissues while driving the vehicle. A further object of the present invention is to allow the interior of a vehicle to have a more orderly appearance by allowing a convenient and readily accessible place to store tissues.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views. The following detailed description is, therefor, not to be taken in a limiting sense, and the scope of the present invention is best defined by the appended claims.

### BRIEF DESCRIPTION OF THE DRAWINGS

In order that the invention may be more fully understood, it will now be described, by way of example, with reference to the accompanying drawings in which.

FIG. 1 is a perspective view of the box of the present invention.

FIG. 2 is a plan view of the top of the box of the present invention.

FIG. 3 is a side view of the box of the present invention.

FIG. 4 is a plan view of the bottom of the box of the present invention.

### LIST OF REFERENCE NUMERALS

With regard to reference numerals used, the following numbering is used throughout the drawing.

10 present invention
12 box
14 top of box
16 slots
18 bottom of box

### DESCRIPTION OF THE PREFERRED EMBODIMENT(S)

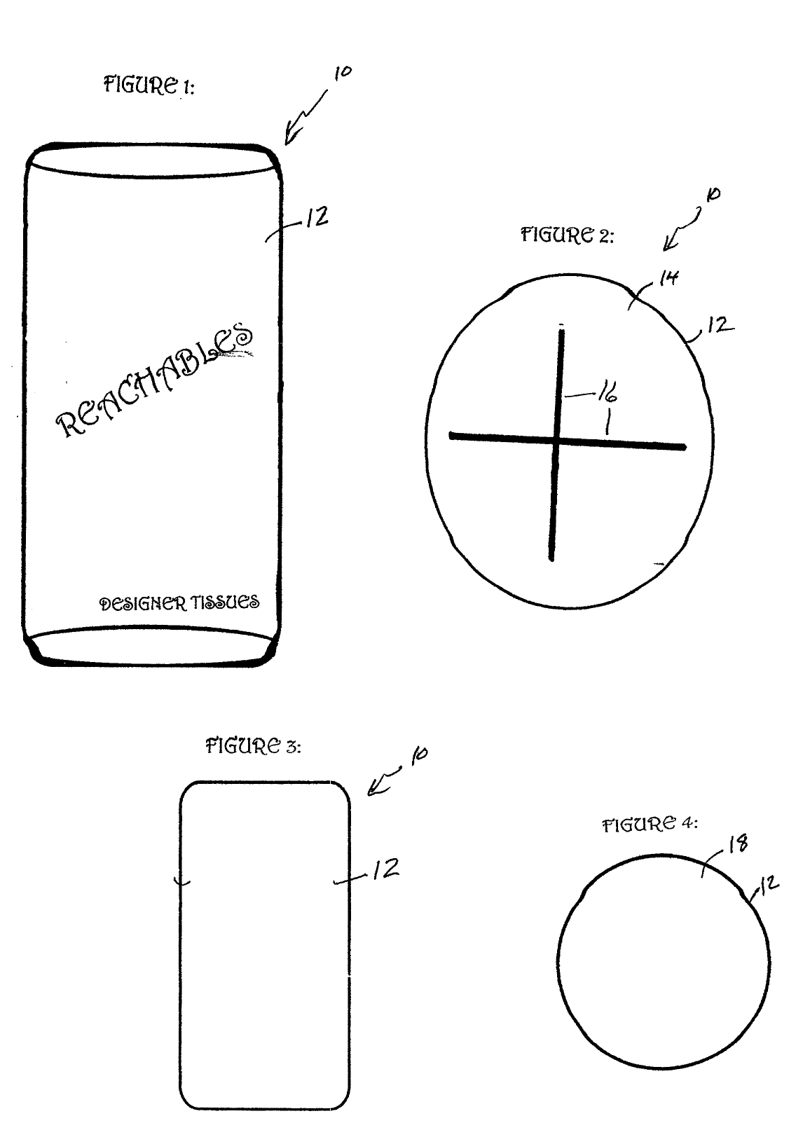

Turning now descriptively to the drawings, in which similar reference characters denote similar elements throughout the several views, FIGS. 1 through 4 illustrate the present invention wherein a cylindrically shaped tissue dispenser is disclosed.

Turning to FIG. 1 therein is shown the present invention 10 being a cylindrically shaped box containing tissues. The box 12 which contains the tissues is cylindrically shaped being about 3½ inches in diameter and about 7 to 8 inches in height. The box 12 is designed to be stored in receptacles which are designed to receive cylindrical containers such as are found in motor vehicles.

Turning to FIG. 2, therein is shown a plan view of the top 14 of the box 12 of the present invention 10 showing a pair of perpendicular slots 16 which are cut into the top 14 of the box 12 which allows the tissues to be removed from the box 12. Top 14 is made of a flexible material such as plastic, paper or the like through which tissue can easily pass.

Turning to FIG. 3, therein is shown a side view of the present invention 10 showing the box 12 of the present invention.

Turning to FIG. 4, therein is shown the bottom 18 of the box 12 of the present invention which bottom is placed into the receptacle which is designed to receive cylindrical containers.

What is claimed to be new and desired to be protected by Letters Patent is set forth in the appended claims:

I claim:

1. An apparatus for dispensing tissue therefrom, comprising:
a) an enclosure,
b) wherein said enclosure is cylindrically shaped, said enclosure having a top end and a bottom end; and,
c) said top end having means for slots disposed therein whereby tissue can be dispensed therethrough.

2. The apparatus of claim 1, wherein said top end is made of flexible material.

3. The apparatus of claim 2, wherein said top end is made of paper material.

4. The apparatus of claim 3, wherein said top end is made of plastic material.

5. The apparatus of claim 4, wherein said enclosure is about 3½ inches in diameter.

6. The apparatus of claim 5, wherein said enclosure is about 7 to 8 inches in height.

7. The apparatus of claim 6, wherein said means for slots further comprises a pair of perpendicular slots.

8. An apparatus for dispensing tissue therefrom, comprising:
a) an enclosure:
b) wherein said enclosure is cylindrically shaped, said enclosure having a top end and a bottom end;
c) wherein said top end is made of flexible material so that tissue can be dispensed therefrom; and,
d) a pair of perpendicular slots disposed in said top end through which tissue can be dispensed.

9. The apparatus of claim 8, wherein said top end is made of paper material.

10. The apparatus of claim 9, wherein said top end is made of plastic material.

11. The apparatus of claim 10, wherein said enclosure is about 3½ inches in diameter.

12. The apparatus of claim 11 wherein said enclosure is about 7 to 8 inches in height.
